(19) United States
(12) Patent Application Publication
(10) Pub. No.: US 2012/0069763 A1
(43) Pub. Date: Mar. 22, 2012

(54) Method and Apparatus for Negotiation Control of Quality of Service Parameters

(75) Inventors: Jie Zhao, Shenzhen (CN); Xin Zhong, Shenzhen (CN); Shuhui Hu, Shenzhen (CN)

(73) Assignee: HUAWEI TECHNOLOGIES CO., LTD., Shenzhen (CN)

(21) Appl. No.: 13/307,990

(22) Filed: Nov. 30, 2011

Related U.S. Application Data
(63) Continuation of application No. PCT/CN2009/072049, filed on May 31, 2009.

(51) Int. Cl. H04W 24/00; H04L 12/26

(52) U.S. Cl. 370/252

(57) ABSTRACT

A method and an apparatus for negotiation control of Quality of Service (QoS) parameters are provided. The method includes: obtaining, by a High Rate Packet Data (HRPD) Serving Gateway (HSGW), static QoS parameters of a User Equipment (UE), where the static QoS parameters include static QoS parameters related to an Access Point Name (APN); establishing, by the HSGW, a Packet Data Network (PDN) connection corresponding to the APN with the UE; and sending, by the HSGW, static QoS parameters related to the APN corresponding to the PDN to an access network to enable the access network to perform QoS authorization, according to the static QoS parameters related to the APN corresponding to the PDN, for establishing an air interface bearer for the UE.

### CROSS-REFERENCE TO RELATED APPLICATIONS

This application is a continuation of International Application No. PCT/CN2009/072049, filed on May 31, 2009, which is hereby incorporated by reference in its entirety.

### FIELD OF THE INVENTION

The present invention relates to the field of communication technologies, and in particular, to a method and an apparatus for negotiation control of Service of Quality (QoS) parameters.

### BACKGROUND OF THE INVENTION

2G and 3G radio cellular networks have multiple standards, for example, Global System for Mobile Communication (GSM), CDMA2000 1x, Universal Mobile Telecommunications System (UMTS), and CDMA2000 1x Evolution Data-Optimized (EV-DO). With the development of technologies, these networks also evolve continuously to provide higher rates and richer services.

Previously, to keep forward compatibility, operators always consider upgrading to the evolved versions of the existing networks during network upgrading, for example, upgrading from GSM to UMTS, or upgrading from CDMA2000 1x to CDMA2000 1x EV-DO. However, with the increasing competition, the change of the business model, and higher requirements of users on the network quality, the interworking between the 3GPP evolved network and the non-3GPP network becomes a hot topic discussed by current standardization organizations, where the interworking between Long Term Evolution (LTE) and High Rate Packet Data (HRPD) networks attracts the most attention.

FIG. 1 is an architecture diagram of interworking between LTE and HRPD networks. As shown in FIG. 1, an HRPD Serving Gateway (HSGW) may obtain all static QoS parameters of a User Equipment (UE) from a Home Subscriber Server (HSS) in an authentication process, including Access Point Name-Aggregate Maximum Bit Rate (APN-AMBR), which is a static QoS parameter related to the APN, Allocation and Retention Priority (ARP), and a global static QoS parameter UE-AMBR, and the HSGW stores these parameters. When the UE initiates establishment of a Packet Data Network (PDN) connection, the HSGW transfers the APN-AMBR to the UE. Therefore, the UE may control the sum of bandwidths of all non-Guaranteed Bit Rate (GBR) services under an APN. However, unlike the HRPD network, an evolved Access Network (eAN) cannot obtain static QoS parameters; QoS authorization is mainly performed by the HSGW, that is, for any QoS request of the UE, the eAN does not perform any processing but forwards the request to the HSGW, and the HSGW performs authorization.

During the implementation of the present invention, the inventor finds that because the HSGW stores the static QoS parameters, QoS control may be performed in the process of establishing bearers and the process of sending data. However, the control efficiency is very low. On the one hand, because the air interface QoS negotiation is performed between the UE and the eAN, but the eAN does not know static QoS parameters, the eAN accepts the request so long as the request is from the UE. When the eAN creates or updates information of A10, the eAN notifies the negotiated air interface QoS to the HSGW. In this case, the HSGW may judge whether the QoS of the air interface is within the authorization range, and if the QoS is not within the authorization range, the HSGW cannot directly send the correct QoS parameters to the eAN through a response message, and can only notify the eAN by actively sending a Session Update subsequently. Therefore, the efficiency is very low, and the speed of establishing bearers is affected. On the other hand, though the HSGW may execute QoS control, for example, control the UE-AMBR, because the HSGW is not so flexible as the eAN in the scheduling control and is not so clear as the eAN about the real-time condition of resources, the implementation is difficult. In addition, though the UE knows the APN-AMBR and may control aggregated bandwidths, the network cannot trust operations of the UE completely; if the HSGW performs all controls, because the HSGW has a wide coverage range, the processing load of the HSGW is further increased.

### SUMMARY OF THE INVENTION

Embodiments of the present invention provide a method and an apparatus for negotiation control of QoS parameters to solve the problem that the QoS control efficiency of the HRPD network is low in the prior art.

The objective of the embodiments of the present invention is realized through the following technical solutions.

A method for negotiation control of QoS parameters includes: obtaining, by an HSGW, static QoS parameters of a UE, where the static QoS parameters include static QoS parameters related to an APN; establishing, by the HSGW, a PDN connection corresponding to the APN with the UE; and sending, by the HSGW, static QoS parameters related to the APN corresponding to the PDN to an access network to enable the access network to perform QoS authorization, according to the static QoS parameters related to the APN corresponding to the PDN, for establishing an air interface bearer for the UE.

An apparatus for negotiation control of QoS parameters includes: an obtaining unit, configured to obtain static QoS parameters of a UE, where the static QoS parameters include static QoS parameters related to an APN; an establishing unit, configured to establish a PDN connection corresponding to the APN with the UE; and a first sending unit, configured to send the static QoS parameters related to the APN corresponding to the PDN to an access network to enable the access network to perform QoS authorization, according to the static QoS parameters related to the APN corresponding to the PDN, for establishing an air interface bearer for the UE.

A method for negotiation control of QoS parameters includes: obtaining, by an HSGW, static QoS parameters of a UE, where the static QoS parameters include static QoS parameters related to an APN; establishing, by the HSGW, a PDN connection corresponding to the APN with the UE; receiving, by the HSGW, dynamic QoS rules sent by a Policy and Charging Rules Function (PCRF); verifying, by the HSGW according to the static QoS parameters and dynamic QoS policies in the dynamic QoS rules, air interface bearer QoS negotiated between the UE and an access network, and sending modified authorized QoS to the access network when it is necessary to modify the negotiated air interface bearer QoS.

An apparatus for negotiation control of QoS parameters includes: an obtaining unit, configured to obtain static QoS parameters of a UE, where the static QoS parameters include static QoS parameters related to an APN; an establishing unit, configured to establish a PDN connection corresponding to the APN with the UE; a first receiving unit, configured to receive dynamic QoS rules sent by a PCRF; and a verifying unit, configured to verify, according to the static QoS parameters and dynamic QoS policies in the dynamic QoS rules, air interface bearer QoS negotiated between the UE and an access network, and send modified authorized QoS to the access network when it is necessary to modify the negotiated air interface bearer QoS.

With the method and apparatus provided in the embodiments of the present invention, the efficiency of QoS negotiations of the current HRPD network may be improved. On the one hand, the eAN may obtain static QoS parameters, especially the static parameters related to the APN, to control QoS negotiations of the UE, or may also perform effective dynamic adjustment for subsequent scheduling of air interface data of the UE and reduce the processing load of the HSGW; on the other hand, if the HSGW finds that the air interface QoS authorized by the eAN does not meet the requirement, the HSGW may directly send the modified QoS to the eAN, instead of updating through the subsequent process, which improves the execution efficiency.

### BRIEF DESCRIPTION OF THE DRAWINGS

The accompanying drawings are intended to help understand the present invention and constitute part of this application rather than a limitation on the present invention. In the drawings:

FIG. 1 is a networking block diagram of interworking between LTE and HRPD networks;

FIG. 2 is a flowchart of a method according to an embodiment of the present invention;

FIG. 3 is a schematic diagram of information exchange according to the embodiment shown in FIG. 2;

FIG. 4 is another schematic diagram of information exchange according to the embodiment shown in FIG. 2;

FIG. 5 is a block diagram showing the composition of an apparatus according to the embodiment shown in FIG. 2;

FIG. 6 is a flowchart of a method according to another embodiment of the present invention;

FIG. 7 is a schematic diagram of information exchange according to the embodiment shown in FIG. 6;

FIG. 8 is another schematic diagram of information exchange according to the embodiment shown in FIG. 6; and

FIG. 9 is a block diagram showing the composition of an apparatus according to the embodiment shown in FIG. 6.

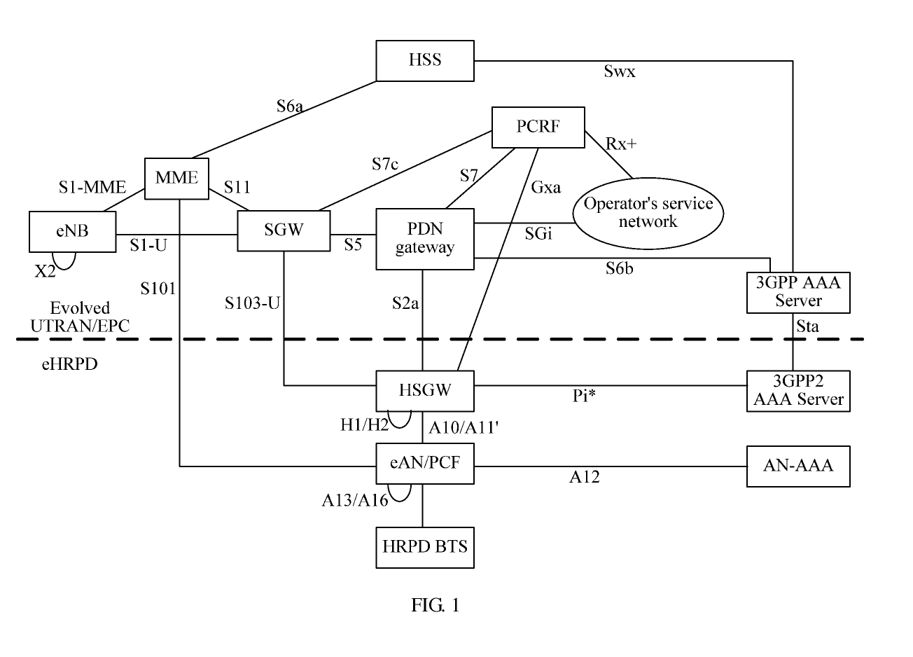

### DETAILED DESCRIPTION OF THE EMBODIMENTS

To make the objective, technical solution, and merits of the present invention clearer, the following describes the embodiments of the present invention in detail with reference to accompanying drawings. The exemplary embodiments of the present invention and the description thereof are illustrative in nature, and shall not be construed as limitations on the present invention.

### Embodiment 1

The embodiment of the present invention provides a method for negotiation control of QoS parameters, and is described in detail with reference to accompanying drawings.

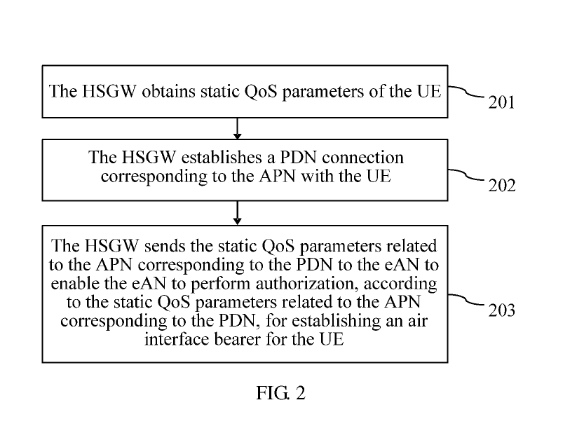

FIG. 2 is a flowchart of a method of this embodiment. As shown in FIG. 2, the method in this embodiment mainly includes the following steps.

201: The HSGW obtains static QoS parameters of the UE, where the static QoS parameters include static QoS parameters related to an APN.

In this embodiment, the HSGW may obtain the static QoS parameters of the UE through access authentication of the UE, or may also obtain the updated static QoS parameters of the UE from the network. All these are based on the prior art, and are not limited by this embodiment.

202: The HSGW establishes a PDN connection corresponding to the APN with the UE.

In this embodiment, the UE and the HSGW establish a PDN connection corresponding to the APN; the UE or HSGW generates an Identifier (ID) for the PDN connection; when the UE generates an ID for the PDN connection, the UE sends the PDN ID with the APN to the HSGW through a request message for establishing the PDN connection; when the HSGW generates an ID for the PDN connection, the HSGW sends the APN and the PDN ID to the UE through a message for notifying that the PDN connection has been established successfully after receiving a PDN connectivity request message that is sent by the UE and carries the APN. This is described through different embodiments.

203: The HSGW sends the static QoS parameters related to the APN corresponding to the PDN to the access network to enable the access network to perform QoS authorization, according to the static QoS parameters related to the APN corresponding to the PDN, for establishing an air interface bearer for the UE.

In this embodiment, the static QoS parameters may also include global static QoS parameters; when the HSGW sends the static QoS parameters to the eAN, the HSGW may also send the global static QoS parameters to the eAN; when the global static QoS parameters are sent, the global static QoS parameters may be sent before step 202, that is, before the UE and the HSGW establish a PDN connection, to the eAN alone, or the global static QoS parameters may also be sent after step 202, that is, after the UE and the HSGW establish a PDN connection, to the eAN together with the static QoS parameters related to the APN.

In this embodiment, when the HSGW sends static QoS parameters related to the APN, the HSGW needs to carry a PDN ID to identify and differentiate different APN QoS parameters.

With the method of this embodiment, when the UE initiates an application, the UE and the eAN negotiate air interface QoS parameters, and the eAN may use the previously obtained static QoS parameters to authorize the QoS parameters. The eAN searches for the corresponding APN QoS parameters according to the PDN ID included in the message sent by the UE; if the eAN obtains the global static QoS parameters at the same time, the eAN may further judge, according to the global static QoS parameters, whether the request of the UE meets the QoS requirement, and if the request meets the QoS requirement, the eAN accepts the request of the UE; if the request does not meet the QoS requirement, the eAN changes the QoS parameters and sends the changed QoS parameters to the UE.

The PDN ID carried in the air interface QoS parameters that the UE requests to negotiate may be included in the ReservationLabel used for identifying the current service flow, or may be carried independently, which is not limited by this embodiment.

The HSGW may send the static QoS parameters to the eAN through an A11-Session Update message, which is not limited by this embodiment.

With the method of this embodiment, the eAN may obtain static QoS parameters, especially the static parameters related to the APN, to control QoS negotiations of the UE, or may also perform effective dynamic adjustment for subsequent scheduling of air interface data of the UE and reduce the processing load of the HSGW, so as to improve the efficiency of QoS negotiations of the current HRPD network.

To make the method of this embodiment clearer, the method of this embodiment is described through different embodiments.

### Embodiment 2

The embodiment of the present invention further provides a method for negotiation control of QoS parameters, which is described in detail with reference to accompanying drawings.

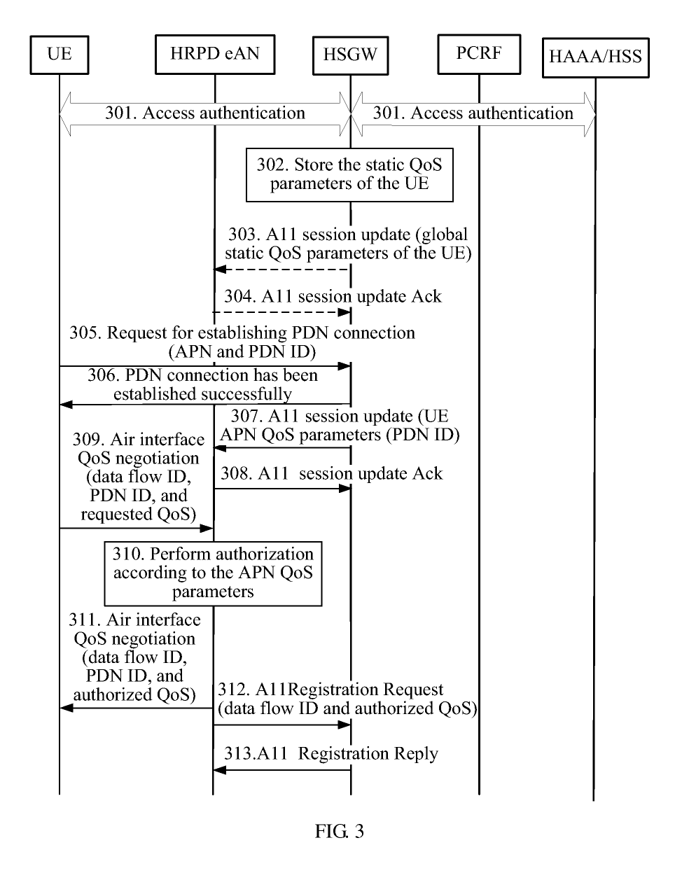

FIG. 3 is a schematic diagram of information exchange by applying the method of this embodiment. As shown in FIG. 3, the method of this embodiment includes the following steps.

301: The UE executes access authentication, and the HSGW may obtain the static QoS parameters of the UE from the HSS or Home Authentication, Authorization, and Accounting server (HAAA) in the authentication process.

302: The HSGW stores these static QoS parameters.

303: The HSGW transfers the global static QoS parameters of the UE, for example, UE-AMBR, to the eAN through an A11-Session Update message.

304: The eAN returns an A11-Session Update Acknowledge to the HSGW, indicating that the parameters are received.

305: To access the Evolved Packet Core network (EPC), the UE sends a Vendor-Specific Network Control Protocol (VSNCP) message to request to establish a PDN connection, where the message carries an APN and an ID generated for the PDN connection.

306: The HSGW sends a VSNCP message to the UE, indicating that the PDN connection is established successfully. The Proxy Mobile IP (PMIP) signaling between the HSGW and the PDN Gateway (P-GW) is omitted here.

307: Because the PDN connection is established successfully, the HSGW transfers static QoS parameters related to the APN corresponding to the PDN to the eAN through an A11-Session Update message, where the message carries a PDN ID.

308: The eAN returns an A11-Session Update Acknowledge to the HSGW, indicating that the parameters are received.

309: The UE initiates an application. Therefore, the UE and the eAN start to negotiate the QoS parameters that the application needs to bear, that is, negotiate the Reservation QoS of the air interface, where the Reservation belongs to the PDN connection established previously. When negotiating the QoS, the UE carries a data flow ID, a PDN ID, and the requested QoS parameters.

310: The eAN judges which PDN connection the request belongs to according to the received PDN ID. Therefore, according to the QoS parameters corresponding to the PDN obtained in step 307 and other QoS parameters, for example, the global static QoS parameters obtained in step 303, the eAN judges whether to accept the QoS requirement requested by the UE.

311: The eAN accepts the request of the UE, and sends a response message to the UE, including the authorized QoS.

312: The eAN sends an A11 Registration Request to the HSGW, and notifies the previously negotiated result of Reservation QoS and the corresponding A10 bearer information to the HSGW.

313: The HSGW returns an A11 Registration Reply.

With the method of this embodiment, the UE generates a PDN ID for the PDN establishing a PDN connection, and sends the PDN ID to the HSGW; the HSGW sends the static QoS parameters related to the APN to the eAN, where the static QoS parameters carry the PDN ID; the eAN obtains the static parameters related to the APN to control QoS negotiations of the UE, or may also perform effective dynamic adjustment for subsequent scheduling of air interface data of the UE and reduce the processing load of the HSGW, so as to improve the efficiency of QoS negotiations of the current HRPD network.

### Embodiment 3

The embodiment of the present invention further provides a method for negotiation control of QoS parameters, which is described in detail with reference to accompanying drawings.

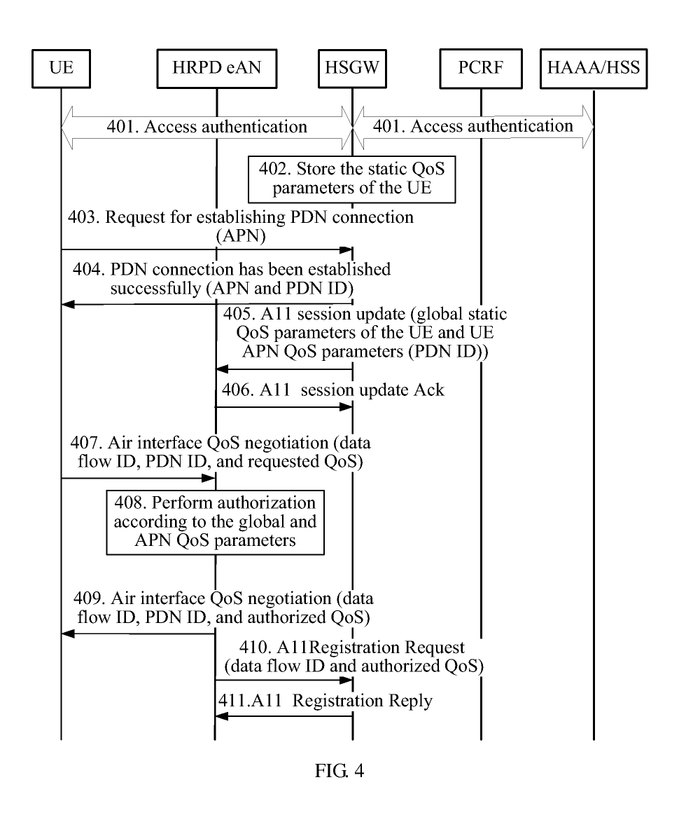

FIG. 4 is a schematic diagram of information exchange by applying the method of this embodiment. As shown in FIG. 4, the method of this embodiment includes the following steps.

401: The UE executes access authentication, and the HSGW may obtain the static QoS parameters of the UE from the HSS/HAAA in the authentication process.

402: The HSGW stores these static QoS parameters.

403: To access the EPC, the UE sends a VSNCP message to request to establish a PDN connection, where the message carries an APN.

404: The HSGW sends a VSNCP message to the UE, indicating that the PDN connection is established successfully, and allocates a PDN ID for the PDN. The PMIP signaling between the HSGW and the P-GW is omitted here.

405: Because the PDN connection is established successfully, the HSGW sends the static QoS parameters related to the APN corresponding to the PDN to the eAN through an A11-Session Update message, where the message carries a PDN ID, and meanwhile, the HSGW further sends the global static QoS parameters of the UE to the eAN.

406: The eAN returns an A11-Session Update Acknowledge to the HSGW, indicating that the parameters are received.

407: The UE initiates an application. Therefore, the UE and the eAN start to negotiate the QoS parameters that the application needs to bear, that is, negotiate the Reservation QoS of the air interface, where the Reservation belongs to the PDN connection established previously. When negotiating the QoS, the UE carries a data flow ID, a PDN ID, and the requested QoS parameters.

408: The eAN judges which PDN connection the request belongs to according to the received message. Therefore, according to the global static QoS parameters and the QoS parameters related to the APN corresponding to the PDN obtained in step 405, the eAN judges whether to accept the QoS requirement requested by the UE.

409: The eAN accepts the request of the UE, and sends a response message to the UE, including the authorized QoS.

410: The eAN sends an A11 Registration Request to the HSGW, and notifies the previously negotiated result of Reservation QoS, namely, the authorized QoS, and the corresponding A10 bearer information to the HSGW.

411: The HSGW returns an A11 Registration Reply.

With the method of this embodiment, the HSGW generates a PDN ID for the PDN that establishes a PDN connection with the UE, and sends the static QoS parameters related to the APN the PDN ID to the eAN, where the static QoS parameters carry the PDN ID; the eAN obtains the static QoS parameters related to the APN to control QoS negotiations of the UE, or may also perform effective dynamic adjustment for subsequent scheduling of air interface data of the UE and reduce the processing load of the HSGW, so as to improve the efficiency of QoS negotiations of the current HRPD network.

### Embodiment 4

The embodiment of the present invention further provides an apparatus for negotiation control of QoS parameters, which is described in detail with reference to accompanying drawings.

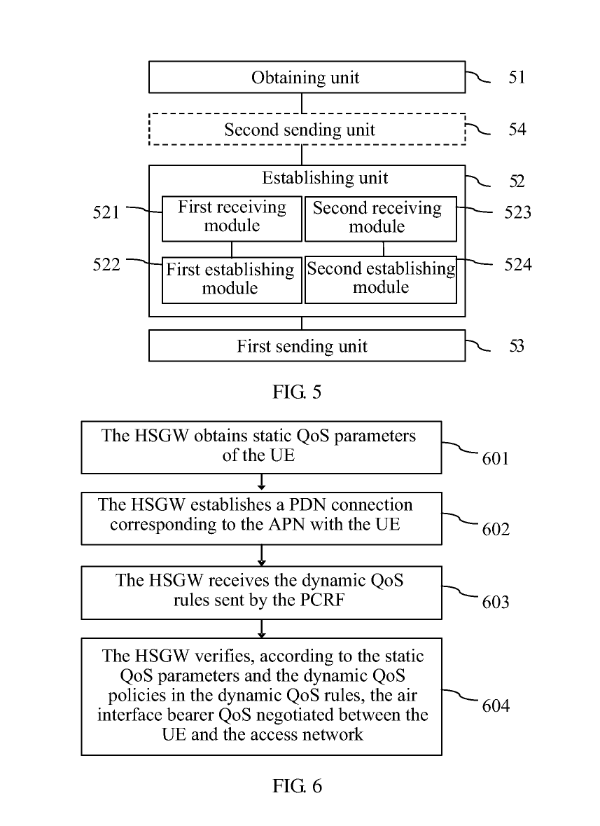

FIG. 5 is a block diagram showing the composition of the apparatus in this embodiment. The apparatus for negotiation control of QoS parameters in this embodiment may be included in the HSGW. As shown in FIG. 5, the apparatus of this embodiment includes:

an obtaining unit 51, configured to obtain static QoS parameters of the UE, where the static QoS parameters include static QoS parameters related to the APN;

an establishing unit 52, configured to establish a PDN connection corresponding to the APN with the UE; and

a first sending unit 53, configured to send the static QoS parameters related to the APN corresponding to the PDN to the access network to enable the access network to perform QoS authorization, according to the static QoS parameters related to the APN corresponding to the PDN, for establishing an air interface bearer for the UE, where the static QoS parameters carry a PDN ID.

According to an embodiment of the present invention, the establishing unit 52 may include:

a first receiving module 521, configured to receive a request message for establishing the PDN connection from the UE, where the request message carries an APN and a PDN ID generated for the PDN connection; and

a first establishing module 522, configured to send a message for notifying that the PDN connection has been established successfully to the UE.

In this embodiment, the UE allocates an ID for the PDN; through the first receiving module 521 and the first establishing module 522 of the establishing unit 52, the PDN connection between the UE and the HSGW may be established.

According to another embodiment of the present invention, the establishing unit 52 may include:

a second receiving module 523, configured to receive a request message for establishing the PDN connection from the UE, where the request message carries an APN; and

a second establishing module 524, configured to send a message for notifying that the PDN connection has been established successfully to the UE, where the message for notifying that the PDN connection has been established successfully carries the APN and the PDN ID generated for the PDN connection.

In this embodiment, the apparatus of this embodiment allocates an ID for the PDN; through the second receiving module 523 and the second establishing module 524 of the establishing unit 52, the PDN connection between the UE and the HSGW may be established.

According to another embodiment of the present invention, the static QoS parameters further include global static QoS parameters. The apparatus may further include:

a second sending unit 54, configured to send global static QoS parameters in the static QoS parameters to the access network after the obtaining unit 51 obtains the static QoS parameters of the UE.

According to another embodiment of the present invention, the aforementioned second sending unit 54 is not required, and only the first sending unit 53 is used to send global static QoS parameters in the static QoS parameters to the access network while sending the static QoS parameters related to the APN corresponding to the PDN to the access network.

The components of the apparatus of this embodiment are used to implement the steps of the method in Embodiment 1, Embodiment 2, and Embodiment 3 respectively; because the steps are already detailed in the foregoing method embodiments, details are not provided here.

With the apparatus of this embodiment, the eAN may obtain static QoS parameters, especially the static QoS parameters related to the APN, to control QoS negotiations of the UE, or may also perform effective dynamic adjustment for subsequent scheduling of air interface data of the UE and reduce the processing load of the HSGW, so as to improve the efficiency of QoS negotiations of the current HRPD network.

### Embodiment 5

The embodiment of the present invention further provides a method for negotiation control of QoS parameters, and is described in detail with reference to accompanying drawings.

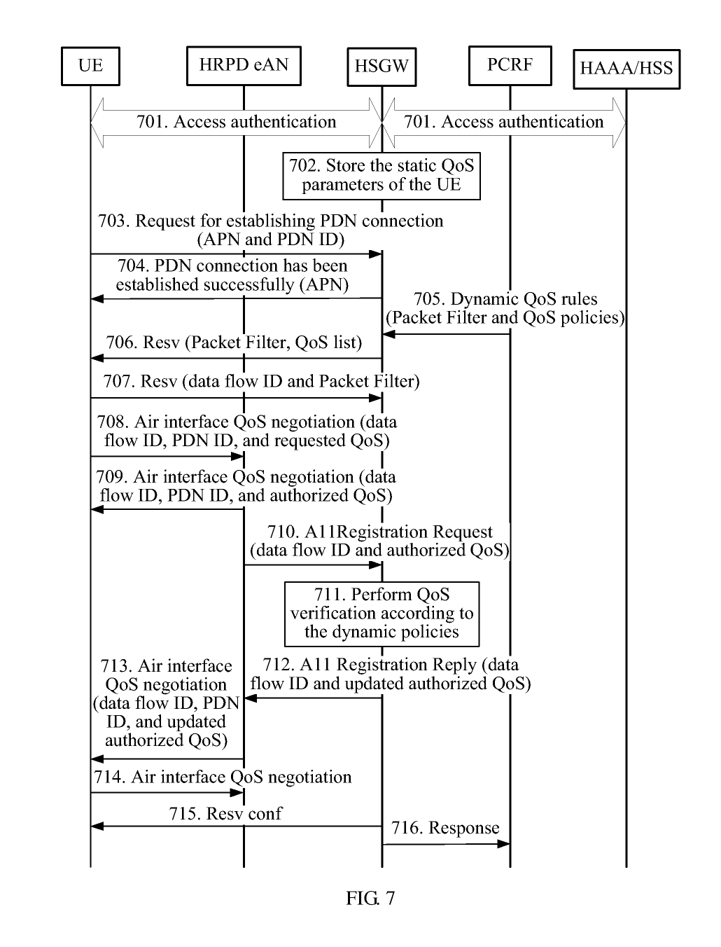

FIG. 6 is a flowchart of a method of this embodiment. As shown in FIG. 6, the method in this embodiment mainly includes the following steps.

601: The HSGW obtains static QoS parameters of the UE, where the static QoS parameters include static QoS parameters related to an APN.

In this embodiment, the HSGW may obtain the static QoS parameters of the UE through access authentication of the UE, or may also obtain the updated static QoS parameters of the UE from the network. All these are based on the prior art, and are not limited by this embodiment.

602: The HSGW establishes a PDN connection corresponding to the APN with the UE.

In this embodiment, the UE and the HSGW establish a PDN connection corresponding to the APN; the UE or HSGW generates an ID for the PDN connection; when the UE generates an ID for the PDN connection, the UE sends the PDN ID together with the APN to the HSGW through a request message for establishing the PDN connection; when the HSGW generates an ID for the PDN connection, the HSGW sends the APN and the PDN ID to the UE through a message for notifying that the PDN connection has been established successfully after receiving the request message for establishing the PDN connection that is sent by the UE and carries the APN. This is already detailed in the foregoing embodiments, and is not further described here.

603: The HSGW receives dynamic QoS rules sent by the PCRF.

The dynamic QoS rules may include the packet filter of a data flow and QoS policies of the data flow.

In this embodiment, the HSGW obtains not only static QoS parameters but also dynamic QoS rules from the PCRF. Moreover, the dynamic QoS rules obtained from the PCRF may be sent directly from the PCRF, or may be obtained by the HSGW from the PCRF according to the request of the UE. This is described through different embodiments. Once the HSGW obtains dynamic QoS rules, the HSGW may send the dynamic QoS rules to the UE, requesting the UE to establish corresponding bearers for the data flow.

604: The HSGW verifies, according to the static QoS parameters and the dynamic QoS policies, the air interface bearer QoS negotiated between the UE and the access network, and if finding through verification that the negotiated air interface bearer QoS needs to be modified, the HSGW sends the modified authorized QoS to the access network.

In this embodiment, the HSGW may send static QoS parameters to the eAN, where the static QoS parameters may further include global static QoS parameters; when the HSGW sends the global static QoS parameters, the HSGW may send the global static QoS parameters before step 602, that is, before the UE and the HSGW establish a PDN connection, to the eAN alone, or may send the global static QoS parameters after step 602, that is, after the UE and the HSGW establish a PDN connection, to the eAN together with the static QoS parameters related to the APN.

In this embodiment, when the HSGW sends static QoS parameters related to the APN, the HSGW needs to carry a PDN ID to identify and differentiate different APN QoS parameters.

With the method of this embodiment, when the UE initiates an application, the UE requests the eAN to negotiate air interface QoS parameters. When the eAN and the UE perform a negotiation, if the eAN includes static QoS parameters, the eAN may also perform authorization according to the static QoS parameters, or else directly accepts the static QoS parameters and sends the negotiated air interface QoS parameters to the HSGW, and the HSGW checks the QoS parameters sent by the eAN. If the QoS parameters meet the QoS requirement of the data flow, the HSGW directly returns a normal response message, or else sends the modified authorized QoS parameters to the eAN through a response. If the eAN finds that the HSGW sends authorized QoS parameters, the eAN negotiates air interface QoS parameters with the UE again, and performs the corresponding bearer mapping adjustment.

The HSGW may send the authorized QoS parameters to the eAN through an A11 Registration Reply, which is not limited by this embodiment.

With the method of this embodiment, when the HSGW finds that the air interface QoS authorized by the eAN does not meet the requirement, the HSGW may directly send the modified QoS to the eAN, instead of updating through the subsequent process, which improves the execution efficiency and improves the efficiency of QoS negotiations of the current HRPD network.

To make the method of this embodiment clearer, the method of this embodiment is described through different embodiments.

### Embodiment 6

The embodiment of the present invention further provides a method for negotiation control of QoS parameters, which is described in detail with reference to accompanying drawings.

FIG. 7 is a schematic diagram of information exchange by applying the method of this embodiment. As shown in FIG. 7, the method of this embodiment includes the following steps.

701: The UE executes access authentication, and the HSGW may obtain the static QoS parameters of the UE from the HSS/HAAA in the authentication process.

702: The HSGW stores these static QoS parameters.

703: To access the EPC, the UE sends a VSNCP message to request to establish a PDN connection, where the message carries an APN and an ID generated for the PDN connection.

704: The HSGW sends a VSNCP message to the UE, indicating that the PDN connection is established successfully. The PMIP signaling between the HSGW and the P-GW is omitted here.

Steps 703 and 704 may also be implemented through steps 403 and 404 in Embodiment 3, and are not further described here.

705: The PCRF sends dynamic QoS rules to the HSGW, including a packet filter of a data flow and QoS policies of the data flow.

706: To establish the bearer adaptable to the dynamic QoS rules, the HSGW sends a Resv message to the UE to trigger the UE to establish a bearer, where the message includes a packet filter and a list of QoS parameters.

707: The UE generates an ID for the packet filter, namely, the data flow, and notifies the mapping relationship to the HSGW through a Resv message.

708: The UE and the eAN start to negotiate the air interface QoS parameters required by the data flow, that is, negotiate the Reservation QoS of the air interface, where the Reservation belongs to the PDN connection established previously. When negotiating the QoS, the UE carries a data flow ID, a PDN ID, and the requested QoS parameters. If the eAN has static QoS parameters of the UE, the eAN performs judgment according to the static QoS parameters, or else directly accepts the request of the UE.

The mode of obtaining static QoS parameters by the eAN may be the mode in Embodiment 2 or Embodiment 3, and is not further described here.

709: The eAN accepts the request of the UE, and sends a response message to the UE, including the authorized QoS.

710: The eAN sends an A11 Registration Request to the HSGW, and notifies the previously negotiated result of Reservation QoS and the corresponding A10 bearer information to the HSGW.

711: The HSGW verifies, according to the dynamic QoS policies and static QoS parameters, whether the QoS authorized by the eAN meets the requirement. Because the eAN cannot judge whether the UE strictly complies with the policy information sent by the network if the eAN has no static QoS parameter or dynamic QoS policy, the HSGW needs to perform verification.

712: The HSGW returns an A11 Registration Reply. Because the HSGW finds that the QoS authorized by the eAN does not meet the requirement, the HSGW sends the updated authorized QoS to the eAN.

In this embodiment, if the HSGW finds that the QoS authorized by the eAN meets the requirement, the HSGW returns an A11 Registration Reply.

713: After receiving the message, because the eAN finds that the HSGW already updates the QoS, the eAN needs to negotiate the air interface QoS with the UE again, and sends a message to the UE.

714: The UE accepts the updated QoS and returns a response to the eAN.

715: The HSGW sends a Resv conf message to the UE, as a response to step 707.

716: The HSGW sends a response message to the PCRF, indicating that the QoS policy is executed successfully.

In this embodiment, because the dynamic QoS rules are by the PCRF actively, after the HSGW obtains the dynamic QoS rules, the HSGW tells the UE to establish a corresponding bearer through step 706, and also needs to know the data flow ID generated by the UE for the packet filter in the dynamic QoS rules through step 707 so as to verify the QoS of the data flow subsequently.

With the method of this embodiment, the PCRF sends the dynamic QoS rules to the HSGW directly; when the HSGW finds, according to the obtained dynamic QoS policies, that the air interface QoS authorized by the eAN does not meet the requirement, the HSGW may directly send the modified QoS to the eAN, instead of updating through the subsequent process, which improves the execution efficiency and improves the efficiency of QoS negotiations of the current HRPD network.

### Embodiment 7

The embodiment of the present invention further provides a method for negotiation control of QoS parameters, which is described in detail with reference to accompanying drawings.

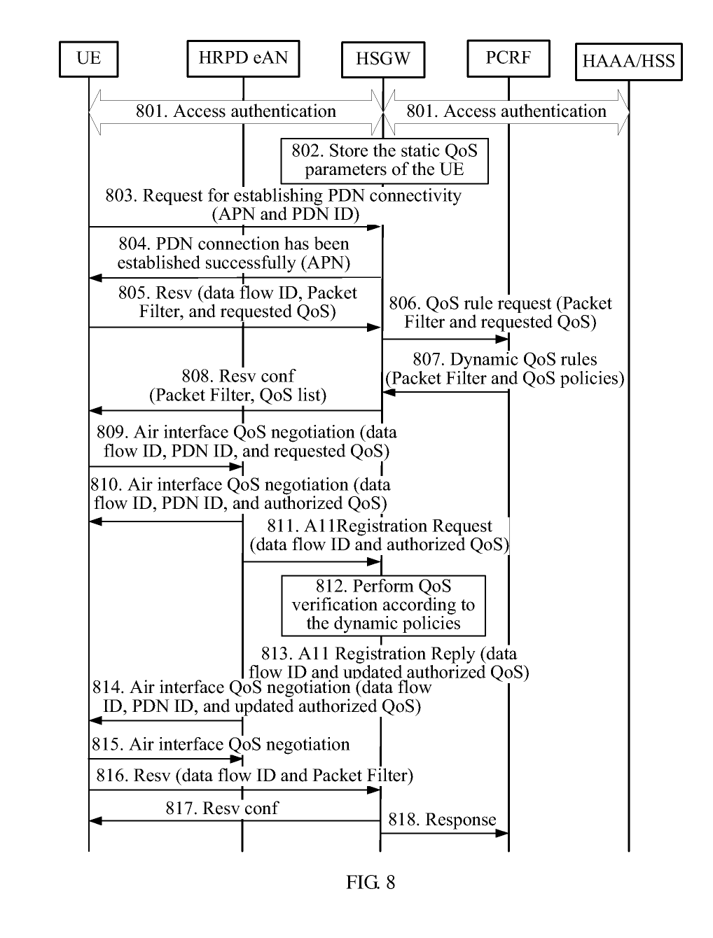

FIG. 8 is a schematic diagram of information exchange by applying the method of this embodiment. As shown in FIG. 8, the method of this embodiment includes the following steps.

801: The UE executes access authentication, and the HSGW may obtain the static QoS parameters of the UE from the HSS/HAAA in the authentication process.

802: The HSGW stores these static QoS parameters.

803: To access the EPC, the UE sends a VSNCP message to request to establish a PDN connection, where the message carries an APN and an ID generated for the PDN connection.

804: The HSGW sends a VSNCP message to the UE, indicating that the PDN connection is established successfully. The PMIP signaling between the HSGW and the P-GW is omitted here.

Steps 803 and 804 may also be implemented through steps 403 and 404 in Embodiment 3, and are not further described here.

805: The UE initiates an application. To request the corresponding network resources, the UE sends a Resv message to the network, where the message includes a data flow ID, a packet filter, and requested QoS parameters.

806: The HSGW requests QoS rules from the PCRF.

807: The PCRF sends dynamic QoS rules to the HSGW according to the policies for the UE, including the packet filter of the data flow and the authorized QoS policies.

808: The HSGW sends the obtained QoS policies to the UE, that is, sends a Resv message, to trigger the UE to establish a bearer, where the message includes a packet filter and a list of QoS parameters.

809: The UE and the eAN start to negotiate the air interface QoS parameters required by the data flow, that is, negotiate the Reservation QoS of the air interface, where the Reservation belongs to the PDN connection established previously. When negotiating the QoS, the UE carries a data flow ID, a PDN ID, and the requested QoS parameters. If the eAN has static QoS parameters of the UE, the eAN performs judgment according to the static QoS parameters, or else directly accepts the request of the UE.

The mode of obtaining static QoS parameters by the eAN may be the mode in Embodiment 2 or Embodiment 3, and is not further described here.

810: The eAN accepts the request of the UE, and sends a response message to the UE, including the authorized QoS.

811: The eAN sends an A11 Registration Request to the HSGW, and notifies the previously negotiated result of Reservation QoS and the corresponding A10 bearer information to the HSGW.

812: The HSGW verifies, according to the dynamic QoS policies and static QoS parameters, whether the QoS authorized by the eAN meets the requirement. Because the eAN cannot judge whether the UE strictly complies with the policy information sent by the network if the eAN has no static QoS parameter or dynamic QoS policy, the HSGW needs to perform verification.

813: The HSGW returns an A11 Registration Reply. Because the HSGW finds that the QoS authorized by the eAN does not meet the requirement, the HSGW sends the updated authorized QoS to the eAN.

In this embodiment, if the HSGW finds that the QoS authorized by the eAN meets the requirement, the HSGW sends an A11 Registration Reply to the eAN.

814: After receiving the message, because the eAN finds that the HSGW already updates the QoS, the eAN needs to negotiate the air interface QoS with the UE again, and sends a message to the UE.

815: The UE accepts the updated QoS and returns a response to the eAN.

816: The UE sends a Resv message to the HSGW, and notifies the mapping relationship between the data flow ID and the packet filter to the HSGW.

817: The HSGW sends a Resv conf message to the UE.

818: The HSGW sends a response message to the PCRF, indicating that the QoS policy is executed successfully.

Compared with Embodiment 6, this embodiment adds steps 805 and 806 for enabling the HSGW to request dynamic QoS rules from the PCRF according to the request of the UE.

In this embodiment, step 816 is used to implement the function of step 707 in Embodiment 6. The difference lies in that, because this embodiment already obtains the data flow ID sent by the UE through step 805 before verification, in this embodiment, the UE notifies the mapping relationship between the data flow ID and the packet filter to the HSGW after, rather than before, the HSGW performs QoS verification.

With the method of this embodiment, according to the request of the UE, the PCRF sends the dynamic QoS rules to the HSGW directly; when the HSGW finds, according to the obtained dynamic QoS policies, that the air interface QoS authorized by the eAN does not meet the requirement, the HSGW may directly send the modified QoS to the eAN, instead of updating through the subsequent process, which improves the execution efficiency and improves the efficiency of QoS negotiations of the current HRPD network.

### Embodiment 8

The embodiment of the present invention further provides an apparatus for negotiation control of QoS parameters, which is described in detail with reference to accompanying drawings.

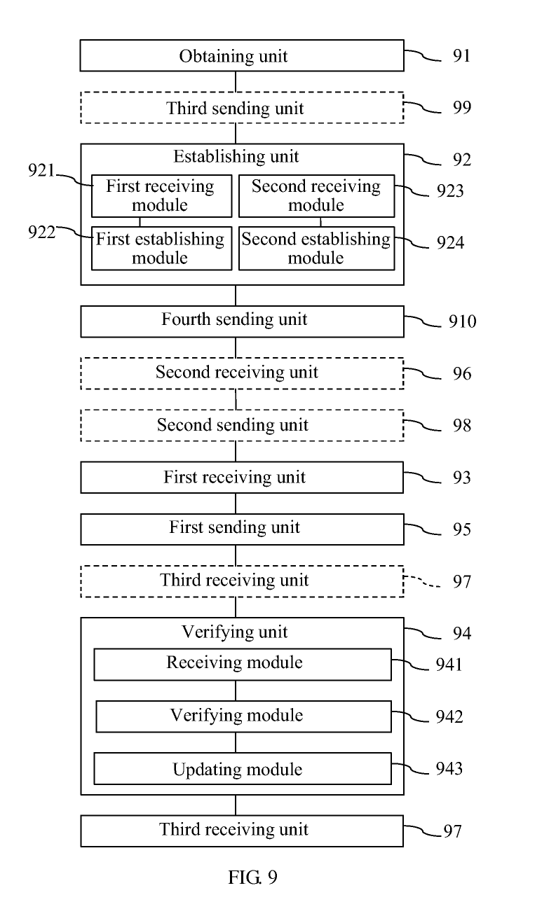

FIG. 9 is a block diagram showing the composition of an apparatus in this embodiment. The apparatus for negotiation control of QoS parameters in this embodiment may be included in the HSGW. As shown in FIG. 9, the apparatus of this embodiment includes:

an obtaining unit 91, configured to obtain static QoS parameters of the UE, where the static QoS parameters include static QoS parameters related to an APN;

an establishing unit 92, configured to establish a PDN connection corresponding to the APN with the UE;

a first receiving unit 93, configured to receive dynamic QoS rules sent by a PCRF, where the dynamic QoS rules may include a packet filter of the data flow and dynamic QoS policies of the data flow; and

a verifying unit 94, configured to verify, according to the static QoS parameters and the dynamic QoS policies, the air interface bearer QoS negotiated between the UE and the access network, and if it is necessary to modify the negotiated air interface bearer QoS, send the modified authorized QoS to the access network.

According to an embodiment of the present invention, the establishing unit 92 may include:

a first receiving module 921, configured to receive a request message for establishing the PDN connection from the UE, where the request message carries an APN and a PDN ID generated for the PDN connection; and

a first establishing module 922, configured to send a message for notifying that the PDN connection has been established successfully to the UE.

In this embodiment, the UE allocates an ID for the PDN; through the first receiving module 921 and the first establishing module 922 of the establishing unit 92, the PDN connection between the UE and the HSGW may be established.

According to another embodiment of the present invention, the establishing unit 92 may include:

a second receiving module 923, configured to receive a request message for establishing the PDN connection from the UE, where the request message carries an APN; and

a second establishing module 924, configured to send a message for notifying that the PDN connection has been established successfully to the UE, where the message for notifying that the PDN connection has been established successfully carries the APN and the PDN ID generated for the PDN connection.

In this embodiment, the apparatus of this embodiment allocates an ID for the PDN; through the second receiving module 923 and the second establishing module 924 of the establishing unit 92, the PDN connection between the UE and the HSGW may be established.

According to another embodiment of the present invention, the apparatus may further include:

a first sending unit 95, configured to: after the first receiving unit 93 receives the dynamic QoS rules sent by the PCRF, send a message carrying the packet filter of the data flow and a list of dynamic QoS parameters to the UE, and trigger the UE to establish a bearer according to the dynamic QoS rules.

According to another embodiment of the present invention, the apparatus may further include:

a second receiving unit 96, configured to receive the resource request message sent by the UE before the first receiving unit receives the dynamic QoS rules sent by the PCRF, where the resource request message carries a data flow ID, a packet filter, and requested QoS parameters; and

a second sending unit 98, configured to request QoS rules from the PCRF according to the resource request message.

According to an embodiment of the present invention, the verifying unit 94 may include:

a receiving module 941, configured to receive an air interface bearer QoS result negotiated between the access network and the UE;

a verifying module 942, configured to verify, according to the static QoS parameters and the dynamic QoS policies, whether the negotiated air interface bearer QoS result meets the requirement; and

an updating module 943, configured to: when the verification result of the verifying module is that the negotiated air interface bearer QoS result does not meet the requirement, send the authorized QoS meeting the requirement to the access network, and negotiate the QoS with the UE through the access network again.

According to another embodiment of the present invention, the apparatus may further include:

a third receiving unit 97, configured to receive the mapping relationship that is sent by the UE and includes the data flow ID corresponding to the packet filter and the packet filter.

In this embodiment, if the dynamic QoS policies are sent by the PCRF actively, the apparatus of this embodiment needs to first receive the data flow ID sent by the UE through the third receiving unit 97 and then verify the QoS negotiated between the UE and the access network through the verifying unit 94; if the dynamic QoS policies are sent according to the request of the UE, because the apparatus of this embodiment already obtains the data flow ID of the UE through the second receiving unit 96, after verifying the QoS negotiated between the UE and the access network, the apparatus receives the mapping relationship that is sent by the UE and includes the data flow ID corresponding to the packet filter and the packet filter.

According to another embodiment of the present invention, the static QoS parameters further include global static QoS parameters. The apparatus may further include:

a third sending unit 99, configured to send the obtained global static QoS parameters to the eAN before the establishing unit establishes a PDN connection corresponding to the APN with the UE; and

a fourth sending unit 910, configured to send the obtained static QoS parameters related to the APN corresponding to the PDN to the eAN after the establishing unit establishes a PDN connection corresponding to the APN with the UE.

According to another embodiment of the present invention, the apparatus may also not include the third sending unit 99 but include only the fourth sending unit 910, which is configured to send the global static QoS parameters and static QoS parameters related to the APN corresponding to the PDN, where the static QoS parameters carry a PDN ID, in the static QoS parameters to the eAN after the obtaining unit 51 obtains the static QoS parameters of the UE.

Through this embodiment, the eAN may authorize the application of the UE according to the static QoS parameters related to the APN corresponding to the PDN or according to the static QoS parameters related to the APN corresponding to the PDN and the global static QoS parameters to obtain the negotiated QoS result.

The components of the apparatus of this embodiment are used to implement the steps of the method in Embodiment 5, Embodiment 6, and Embodiment 7 respectively; because the steps are already detailed in the foregoing method embodiments, details are not provided here.

With the apparatus of this embodiment, the PCRF sends the dynamic QoS rules to the HSGW; when the HSGW finds, according to the obtained dynamic QoS policies, that the air interface QoS authorized by the eAN does not meet the requirement, the HSGW may directly send the modified QoS to the eAN, instead of updating through the subsequent process, which improves the execution efficiency and improves the efficiency of QoS negotiations of the current HRPD network.

The steps of the method or algorithm described with reference to the embodiments herein may be implemented directly through hardware or through a software module executed by a processor, or through both of them. The software module may be placed in a Random Access Memory (RAM), a memory, a Read Only Memory (ROM), an electrically programmable ROM, an electrically erasable programmable ROM, a register, a hard disk, a removable disk, a Compact Disk-Read Only Memory (CD-ROM), or any other form of storage medium known in the art.

The objective, technical solution, and benefits of the embodiments of the present invention are detailed above. Although the invention has been described through some exemplary embodiments, the invention is not limited to such embodiments. All modifications, equivalent replacements, and improvements made by those skilled in the art without departing from the spirit and principle of the invention shall fall within the scope of the invention.

1. A method for negotiation control of Quality of Service (QoS) parameters, the method comprising:
obtaining, by a High Rate Packet Data (HRPD) Serving Gateway (HSGW), static QoS parameters of a User Equipment (UE), wherein the static QoS parameters comprise static QoS parameters related to an Access Point Name (APN);
establishing, by the HSGW, a Packet Data Network (PDN) connection corresponding to the APN with the UE; and
sending, by the HSGW, static QoS parameters related to the APN corresponding to the PDN to an access network to enable the access network to perform QoS authorization, according to the static QoS parameters related to the APN corresponding to the PDN, for establishing an air interface bearer for the UE.

2. The method according to claim 1, wherein establishing the PDN connection comprises:
receiving, by the HSGW, a request message for establishing the PDN connection from the UE, wherein the request message carries the APN and a PDN Identifier (ID) generated for the PDN connection; and
sending, by the HSGW, a message to notify the UE that the PDN connection has been established successfully.

3. The method according to claim 1, wherein establishing the PDN connection comprises:
receiving, by the HSGW, a request message for establishing the PDN connection from the UE, wherein the request message carries the APN; and
sending, by the HSGW, a message to notify the UE that the PDN connection has been established successfully, wherein the message that the PDN connection has been established successfully carries the APN and a PDN ID generated for the PDN connection.

4. The method according to claim 1, wherein the static QoS parameters further comprise global static QoS parameters, the method further comprising:
sending, by the HSGW, the global static QoS parameters to the access network before establishing the PDN connection.

5. The method according to claim 1, wherein the static QoS parameters further comprise global static QoS parameters the method further comprising:
sending, by the HSGW, the global static QoS parameters to the access network while sending the static QoS parameters.

6. The method according to claim 1, wherein sending the static QoS parameters comprises:
sending, by the HSGW, static QoS parameters related to the APN corresponding to the PDN, to the access network, wherein the static QoS parameters carry the PDN ID.

7. An apparatus for negotiation control of Quality of Service (QoS) parameters, the apparatus comprising:
an obtaining unit, configured to obtain static QoS parameters of a User Equipment (UE), wherein the static QoS parameters comprise static QoS parameters related to an Access Point Name (APN);
an establishing unit, configured to establish a Packet Data Network (PDN) connection corresponding to the APN with the UE; and
a first sending unit, configured to send static QoS parameters related to the APN corresponding to the PDN to an access network to enable the access network to perform QoS authorization, according to the static QoS parameters related to the APN corresponding to the PDN, for establishing an air interface bearer for the UE, wherein the static QoS parameters carry a PDN Identifier (ID).

8. The apparatus according to claim 7, wherein the establishing unit comprises:
a first receiving module, configured to receive a request message for establishing the PDN connection from the UE, wherein the request message carries an APN and a PDN ID generated for the PDN connection; and
a first establishing module, configured to send a message for notifying that the PDN connection has been established successfully to the UE.

9. The apparatus according to claim 7, wherein the establishing unit comprises:
a second receiving module, configured to receive a request message for establishing the PDN connection from the UE, wherein the request message carries an APN; and
a second establishing module, configured to send a message for notifying the UE that the PDN connection has been established successfully, wherein the message that the PDN connection has been established successfully carries the APN and a PDN ID generated for the PDN connection.

10. The apparatus according to claim 7, wherein the static QoS parameters further comprise global static QoS parameters and the apparatus further comprises:
a second sending unit, configured to send the global static QoS parameters in the static QoS parameters to the access network after the obtaining unit obtains the static QoS parameters of the UE.

11. The apparatus according to claim 7, wherein the static QoS parameters further comprise global static QoS parameters, and the first sending unit is further configured to send the global static QoS parameters in the static QoS parameters to the access network when sending the static QoS parameters related to the APN corresponding to the PDN to the access network.

12. A method for negotiation control of Quality of Service (QoS) parameters, the method comprising:
obtaining, by a High Rate Packet Data (HRPD) Serving Gateway (HSGW), static QoS parameters of a User Equipment (UE), wherein the static QoS parameters comprise static QoS parameters related to an Access Point Name (APN);
establishing, by the HSGW, a Packet Data Network (PDN) connection corresponding to the APN with the UE;
receiving, by the HSGW, dynamic QoS rules sent by a Policy and Charging Rules Function (PCRF);
verifying, by the HSGW according to dynamic QoS policies in the dynamic QoS rules and the static QoS parameters, air interface bearer QoS negotiated between the UE and an access network; and
determining if it is necessary to modify the negotiated air interface bearer QoS, and, if so, sending the modified authorized air interface bearer QoS to the access network.

13. The method according to claim 12, wherein establishing the PDN connection comprises:
receiving, by the HSGW, a request message for establishing the PDN connection from the UE, wherein the request message carries an APN and a PDN Identifier (ID) generated for the PDN connection; and
sending, by the HSGW, a message to notify the UE that the PDN connection has been established successfully.

14. The method according to claim 12, wherein establishing the PDN connection comprises:
receiving, by the HSGW, a request message for establishing the PDN connection from the UE, wherein the request message carries an APN; and
sending, by the HSGW, a message to notify the UE that the PDN connection has been established successfully, wherein the message that the PDN connection has been established successfully carries the APN and a PDN ID generated for the PDN connection.

15. The method according to claim 12, wherein after receiving the dynamic QoS rules sent by the PCRF, the method comprises:
sending, by the HSGW, a message carrying a packet filter of a data flow and a list of QoS parameters to the UE, and
triggering the UE to establish a bearer according to the dynamic QoS rules.

16. The method according to claim 12, wherein before receiving the dynamic QoS rules, the method further comprises:
receiving, by the HSGW, a resource request message sent by the UE, wherein the resource request message carries a data flow ID, a packet filter, and requested QoS parameters; and
requesting, by the HSGW, QoS rules from the PCRF according to the resource request message.

17. The method according to claim 12, wherein verifying the air interface bearer QoS negotiated between the UE and the access network, comprises:
receiving, by the HSGW, a QoS result negotiated between the access network and the UE; and
verifying, by the HSGW according to the static QoS parameters and dynamic QoS policies in the dynamic QoS rules, whether the negotiated QoS result meets a requirement;
wherein, if the negotiated QoS result does not meet the requirement, the HSGW sends QoS meeting the requirement to the access network to enable the access network to perform a QoS negotiation with the UE again.

18. The method according to claim 17, wherein the static QoS parameters further comprise global static QoS parameters,
wherein, before establishing the PDN connection, the method further comprises sending, by the HSGW, the global static QoS parameters to the access network; and
after establishing the PDN connection, the method further comprises: sending, by the HSGW, the static QoS parameters related to the APN corresponding to the PDN to the access network to enable the access network to perform QoS authorization for an application of the UE according to the static QoS parameters related to the APN or according to the global static QoS parameters and the static QoS parameters related to the APN to obtain the negotiated QoS result.

19. The method according to claim 17, wherein the static QoS parameters further comprise global static QoS parameters, wherein after the establishing the PDN connection, the method comprises:
sending, by the HSGW, the global static QoS parameters and the static QoS parameters related to the APN corresponding to the PDN to the access network to enable the access network to perform QoS authorization for an application of the UE according to the static QoS parameters related to the APN or according to the global static QoS parameters and the static QoS parameters related to the APN to obtain the negotiated QoS result.

20. An apparatus for negotiation control of Quality of Service (QoS) parameters, the apparatus comprising:
an obtaining unit, configured to obtain static QoS parameters of a User Equipment (UE), wherein the static QoS parameters comprise static QoS parameters related to an Access Point Name (APN);
an establishing unit, configured to establish a Packet Data Network (PDN) connection corresponding to an APN with the UE;
a first receiving unit, configured to receive dynamic QoS rules sent by a Policy and Charging Rules Function (PCRF); and
a verifying unit, configured to verify, according to the static QoS parameters and dynamic QoS policies in the dynamic QoS rules, air interface bearer QoS negotiated between the UE and an access network, and, if necessary, to modify the negotiated air interface bearer QoS and send the modified authorized QoS to the access network.

21. The apparatus according to claim 20, wherein the establishing unit comprises:
a first receiving module, configured to receive a request message for establishing the PDN connection from the UE, wherein the request message carries an APN and a PDN Identifier (ID) generated for the PDN connection; and
a first establishing module, configured to send a message to notify the UE that the PDN connection has been established successfully.

22. The apparatus according to claim 20, wherein the establishing unit comprises:
a second receiving module, configured to receive a request message for establishing the PDN connection from the UE, wherein the request message carries an APN; and
a second establishing module, configured to send a PDN connectivity success message to the UE, wherein the message for notifying that the PDN connection has been established successfully carries the APN and a PDN ID generated for the PDN connection.

23. The apparatus according to claim 20, further comprising:
a second receiving unit, configured to receive a resource request message sent by the UE before the first receiving unit receives the dynamic QoS rules sent by the PCRF, wherein the resource request message carries a data flow ID, a packet filter, and requested QoS parameters; and
a second sending unit, configured to request QoS rules from the PCRF according to the resource request message.

24. The apparatus according to claim 20, wherein the verifying unit comprises:
a receiving module, configured to receive a QoS result negotiated between the access network and the UE;
a verifying module, configured to verify, according to the dynamic QoS policies, whether the negotiated QoS result meets a requirement; and
an updating module, configured to, when the verification result of the verifying module is that the negotiated QoS result does not meet the requirement, send QoS meeting the requirement to the access network to enable the access network to perform a QoS negotiation with the UE.

25. The apparatus according to claim 20, wherein the static QoS parameters further comprise global static QoS parameters, and the apparatus further comprises:
a fourth sending unit, configured to, after the establishing unit establishes the PDN connection corresponding to the APN with the UE, send the static QoS parameters related to the APN corresponding to the PDN to enable the access network to perform QoS authorization for an application of the UE according to the static QoS parameters related to the APN corresponding to the PDN.

26. The apparatus according to claim 20, wherein the static QoS parameters further comprise global static QoS parameters, and the apparatus further comprises:
a fourth sending unit, configured to, after the establishing unit establishes the PDN connection corresponding to the APN with the UE, send the static QoS parameters related to the APN corresponding to the PDN and the global static QoS parameters to the access network to enable the access network to perform QoS authorization for an application of the UE according to the static QoS parameters related to the APN corresponding to the PDN and the global static QoS parameters to obtain a negotiated QoS result.

27. The apparatus according to claim 20, further comprising:
a third sending unit, configured to, before the establishing unit establishes the PDN connection corresponding to the APN with the UE, send the global static QoS parameters to the access network to enable the access network to perform QoS authorization for the application of the UE according to the static QoS parameters related to the APN corresponding to the PDN and the global static QoS parameters to obtain the negotiated QoS result.
